(19) United States
(12) Patent Application Publication
(10) Pub. No.: US 2012/0297770 A1
(43) Pub. Date: Nov. 29, 2012

(54) EXHAUST-GAS POWER-RECOVERY TURBINE FOR A TURBO COMPOUND SYSTEM

(76) Inventors: Thomas Figler, Crailsheim (DE); Markus Kley, Ellwangen (DE)

(21) Appl. No.: 13/305,935

(22) Filed: Nov. 29, 2011

Related U.S. Application Data
(63) Continuation of application No. PCT/EP2010/004817, filed on Aug. 6, 2010.

(30) Foreign Application Priority Data
Aug. 27, 2009 (DE) 10 2009 038 772.2

(51) Int. Cl. F02B 41/00

(52) U.S. Cl. 60/624

(57) ABSTRACT

The invention concerns an exhaust-gas power-recovery turbine for a turbo compound system, in particular of a motor vehicle, including: a turbine shaft, which at the first end thereof or in the area of the first end carries a rotor to be impinged by the exhaust gas flow of an internal combustion engine, in order to convert exhaust gas energy into drive power; and which at the second end thereof carries a pinion, which is designed to be brought into a driving connection with the crankshaft of the internal combustion engine, in order to transmit the drive power to the crankshaft. The invention is characterised in that that the turbine shaft is supported in the area of the rotor by means of a radial plain bearing and in the area of the pinion by means of a radial rolling-element bearing.

This is a continuation of PCT application No. PCT/EP2010/004817, entitled “EXHAUST-GAS POWER-RECOVERY TURBINE FOR A TURBO COMPOUND SYSTEM”, filed Aug. 6, 2010, which is incorporated herein by reference.

### BACKGROUND OF THE INVENTION

1. Field of the Invention

The present invention concerns an exhaust-gas power-recovery turbine for a turbo compound system, that is to say a system in a drive train, in particular a vehicle drive train, fitted with an internal combustion engine for driving the drive train, in which exhaust gas stream an exhaust-gas power-recovery turbine is arranged. The exhaust-gas power-recovery turbine can for instance be arranged in the exhaust gas stream downstream of the turbine of a turbo charger or drive additionally a compressor for charging the internal combustion engine.

2. Description of the Related Art

For further reference to the state of the art, documents DE 10 2005 025 272 A1, EP 0 171 882 A1 and EP 1 197 638 A2 may prove useful.

Energy is extracted from the exhaust gas by means of the exhaust-gas power-recovery turbine and transformed into mechanical energy or into drive power. Said energy then is used for additional drive of the output shaft of the internal combustion engine, which usually is designed as a crankshaft.

Due to the size and the profiling of the exhaust-gas power-recovery turbines in turbo compound systems, their rotor, also called turbine wheel, is driven with rotation speeds of up to 70,000 rpm or even more in individual cases. Due to these extremely high rotation speeds, the turbine shaft on which the rotor of the exhaust-gas power-recovery turbine had been supported so far, is now exclusively supported by plain bearings which are usually arranged in a common housing.

Although the disclosed turbo compound systems of different manufacturers operate to the satisfaction of their customers comparative tests have now shown that the degree of efficiency of the turbo compound system undesirably decreases with the lifetime of the system. The cause for this unexpectedly decreasing degree of efficiency was unknown so far.

The object of the present invention, and what is needed in the art, is then to offer an exhaust-gas power-recovery turbine for a turbo compound system, which enables the degree of efficiency of the turbo compound system to remain more or less constantly high over the whole lifetime and the undesirable decrease noticed to be prevented.

### SUMMARY OF THE INVENTION

The object of the invention is satisfied with, and the present invention provides, an exhaust-gas power-recovery turbine for a turbo compound system as follows:

I) An exhaust-gas power-recovery turbine for a turbo compound system, in particular of a motor vehicle, including
a turbine shaft, which at the first end thereof or in the area of the first end carries a rotor to be impinged by the exhaust gas flow of an internal combustion engine in order to convert exhaust gas energy into drive power; and
which at the second end thereof carries a pinion, which is designed to be brought into a driving connection with the crankshaft of the internal combustion engine in order to transmit the drive power to the crankshaft;
   characterised in that
the turbine shaft is supported in the area of the rotor by means of a radial plain bearing and in the area of the pinion by means of a radial rolling-element bearing.
   II) An exhaust-gas power-recovery turbine for a turbo compound system, in particular of a motor vehicle, including
a turbine shaft, which at the first end thereof or in the area of the first end carries a rotor to be impinged by the exhaust gas flow of an internal combustion engine in order to convert exhaust gas energy into drive power; and
which at the second end thereof carries a pinion, which is designed to be brought into a driving connection with the crankshaft of the internal combustion engine in order to transmit the drive power to the crankshaft;
   characterised in that
the turbine shaft is supported in the area of the rotor by means of a floating bushing in a housing, which forms an external oil-filled bearing gap with respect to the housing and an internal oil-filled bearing gap with respect to the turbine shaft and is relatively rotatable with respect to the housing and the turbine shaft, and
is supported in the area of the pinion by means of a single simple plain bearing, which forms in radial direction a single oil-filled bearing gap between the turbine shaft and the housing or another housing.
   III) An exhaust-gas power-recovery turbine for a turbo compound system, in particular of a motor vehicle, including
a turbine shaft, which at the first end thereof or in the area of the first end carries a rotor to be impinged by the exhaust gas flow of an internal combustion engine in order to convert exhaust gas energy into drive power; and
which at the second end thereof carries a pinion, which is designed to be brought into a driving connection with the crankshaft of the internal combustion engine in order to transmit the drive power to the crankshaft;
   characterised in that
the turbine shaft is supported in the area of the rotor by means of a roller bearing, which is enclosed by a plain bearing or an oil damper with an oil-filled bearing gap and/or encloses the same, and
is supported in the area of the pinion by means of a simple roller bearing, which has no enclosing or enclosed oil-filled bearing gap of a plain bearing or oil damper.
   IV) A flow compressor for a turbo compound system or a turbo charger, in particular of a motor vehicle, including
a drive shaft, which at the first end thereof or in the area of the first end carries a rotor to be positioned in a fresh air flow leading to an internal combustion engine, in order to compress the fresh air flow; and
which at the second end thereof carries a pinion, which is designed to be brought into a driving connection with the crankshaft of the internal combustion engine or of a turbine or exhaust gas turbine in order to transmit the drive power to the rotor;
   characterised in that
the drive shaft is supported in the area of the rotor by means of a radial plain bearing and in the area of the pinion by means of a radial rolling-element bearing.
   V) A flow compressor for a turbo compound system or a turbo charger, in particular of a motor vehicle, including
a drive shaft, which at the first end thereof or in the area of the first end carries a rotor to be positioned in a fresh air flow leading to an internal combustion engine, in order to compress the fresh air flow; and
which at the second end thereof carries a pinion, which is designed to be brought into a driving connection with the crankshaft of the internal combustion engine or of a turbine or exhaust gas turbine in order to transmit the drive power to the rotor;
   characterised in that
the drive shaft is supported in the area of the rotor by means of a floating bushing in a housing, which forms an external oil-filled bearing gap with respect to the housing and an internal oil-filled bearing gap with respect to the drive shaft and is relatively rotatable with respect to the housing and the drive shaft, and
is supported in the area of the pinion by means of at least one or a single simple plain bearing, which forms in radial direction a single oil-filled bearing gap between the drive shaft and the housing or another housing.
   VI) A flow compressor for a turbo compound system or a turbo charger, in particular of a motor vehicle, including
a drive shaft, which at the first end thereof or in the area of the first end carries a rotor to be positioned in a fresh air flow leading to an internal combustion engine, in order to compress the fresh air flow; and
which at the second end thereof carries a pinion, which is designed to be brought into a driving connection with the crankshaft of the internal combustion engine or of a turbine or exhaust gas turbine in order to transmit the drive power to the rotor;
   characterised in that
the drive shaft is supported in the area of the rotor by means of a roller bearing, which is enclosed by a plain bearing or an oil damper with an oil-filled bearing gap and/or encloses the same, and
is supported in the area of the pinion by means of a simple roller bearing, which has no enclosing or enclosed oil-filled bearing gap of a plain bearing or oil damper.

The invention is based on the knowledge that the degree of efficiency is increasingly reduced due to the fact certain teeth increasingly tend to mesh incorrectly in the gear drive between the exhaust-gas power-recovery turbine and the output shaft of the internal combustion engine which is usually designed as a crankshaft, when the gear drive is used for transmitting the drive power from the exhaust-gas power-recovery turbine to the output shaft. The inventors have noticed that said incorrect tooth meshing occurs in particular in the area of the intermeshing engagement between the pinion of the turbine shaft and one toothed gear associated therewith, which usually has a comparatively substantially larger external diameter. This malpositioning in the tooth meshing can even cause the teeth to jam against one another. The cause thereof is premature wear of the teeth of the pinion so that said teeth cannot stay in perfect engagement with the teeth of the gear any longer. To the best of the inventors' knowledge, said wear can again be attributed to inappropriate superimposition of the forces resulting from the turbine shaft dynamics and the interlocking forces applied to the pinion. The teeth of the pinion are in comparison to the teeth of the gear more strongly affected by this wear since the pinion has a substantially smaller external diameter than the gear and hence relative to a given tooth of the pinion, said tooth substantially more often rolls off at the teeth of the gear, than a given tooth of the gear rolls off at the teeth of the pinion.

The superimposition of the forces resulting from the turbine shaft dynamics and the interlocking forces causes deflection of the turbine shaft at the axial end to which the pinion is associated. A corresponding deflection of the turbine shaft can also take place at its opposite axial end. In order to avoid said undesirable deflection the turbine shaft according to the invention is supported in the area of the pinion by means of a radial roller bearing in spite of the high rotation speeds in operation, whereas conversely it is supported in the area of the rotor of the exhaust-gas power-recovery turbine by means of a radial plain bearing. The radial plays in the radial rolling-element bearing are smaller than in a radial plain bearing.

According to an alternative form of embodiment of the invention, the turbine shaft is supported in the area of the rotor by means of a floating bushing in a housing, which forms an external oil-filled bearing gap with respect to the housing and an internal oil-filled bearing gap with respect to the turbine shaft and is relatively rotatable with respect to the housing and the turbine shaft, and moreover the turbine shaft is supported in the area of the pinion by means of a simple plain bearing, consequently by means of a plain bearing, which forms in radial direction a single oil-filled bearing gap between the turbine shaft and the housing. The housing can thus be the same component in which the turbine shaft is also supported in the area of the rotor. Alternately, a separate component can however be provided, here designated as a further housing.

According to a third form of embodiment of the invention, the bearing also differentiates by at least one oil-filled bearing gap in the area of the rotor from the bearing in the area of the pinion. It should be noted that the bearing is designed as a roller bearing in the area of the rotor, which is enclosed by a plain bearing with at least one oil-filled bearing gap and/or encloses such a plain bearing. It should be noted that the bearing is designed as a simple roller bearing in the area of the pinion, that is to say that rolling elements are arranged in the bearing gap between the turbine shaft and the housing, and there is no additional oil-filled bearing gap radially outside or radially inside the roller bearing.

According to an advantageous embodiment, the turbine shaft which carries the rotor of the exhaust-gas power-recovery turbine, which in particular is designed as a radial axial turbine, is supported in the area of the pinion by means of an axial plain bearing, whereas the axial plain bearing and the radial plain bearing may enclose the radial roller bearing in particular on both sides between them. Alternately or additionally, an axial roller bearing may be provided for supporting the turbine shaft, in particular in the area of the pinion, whereas a single combined axial-radial-roller bearing is advantageous. It goes without saying that the axial bearing, regardless whether it is designed as a roller bearing or a plain bearing, can also be arranged on another position, for instance in the area of the rotor.

A single axial bearing for supporting the turbine shaft is provided to create a particularly appropriate form of embodiment. Besides, two radial bearings can exclusively be provided, in particular said radial roller bearing and said radial plain bearing.

The roller bearing can include rolling elements made of traditional rolling element material, in particular metal. The rolling elements are particularly advantageously made of ceramic material.

According to a preferred form of embodiment, rolling elements in the form of cylinders, cones or needles, instead of balls, as they can be used basically also in an embodiment according to the invention, are usually inserted between an inner ring and an outer ring of the roller bearing. In order to reduce the wear of the roller bearing in the first form of embodiment according to the invention, an oil damper can be incorporated in the bearing, to be more accurate, between the bearing and a housing in which the bearing is received, and/or provided between the bearing and the turbine shaft. Such an oil damper can for instance be produced inasmuch as a bearing ring, which can be designed integrally with the inner ring or the outer ring or can be provided in addition to the same and is mounted in particular on the inner ring or the outer ring, as seen in radial direction of the turbine shaft, between the turbine shaft and the housing, and a lubricating oil-filled annular gap is formed between the bearing ring and the housing and/or between the bearing ring and the turbine shaft. Pressurised oil can in particular be injected into the annular gap. The wear of the bearings as well as the sound level can be reduced by the damping effect of the oil.

A corresponding oil-filled annular gap can additionally or alternately also be provided in or on the radial plain bearing, inasmuch as a bearing ring is accordingly arranged there. The bearing rings have in particular a cylindrical form but can also have deviating forms, such as a conical or a stepped shape.

The pinion is particularly advantageously arranged, in particular supported cantilevered, on an axial end of the turbine shaft, in particular outside a housing, which encloses the different bearings together or in which or on which the bearings are mounted. The rotor of the exhaust-gas power-recovery turbine can be arranged on the other axial end of the turbine shaft, in particular also cantilevered. Cantilevered support means here that no additional bearing is provided for supporting the turbine shaft and in particular for supporting the corresponding component, as seen in axial direction outside the corresponding component (pinion or rotor). By bearing in the sense of the present description is hence always meant such support points in the turbo compound system in which two components revolve relative to one another with a different rotation speed or in which one component rotates and the other is held stationary, that is to say does not rotate.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows a first drive connection realised according to the invention between an exhaust-gas power-recovery turbine and a pinion in mechanical drive connection with the output shaft of the internal combustion engine (non-represented) in accordance with a turbo compound system according to the invention;

FIG. 2 shows a modified embodiment with respect to FIG. 1, in which the roller bearing is designed as a combined axial-radial-roller bearing;

FIG. 3 shows an embodiment according to FIG. 1 with an additional squeeze oil damper, which encloses the radial roller bearing in the circumferential direction;

FIG. 4 shows an embodiment according to the second arrangement according to the invention; and

FIG. 5 shows an embodiment according to the third arrangement according to the invention.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

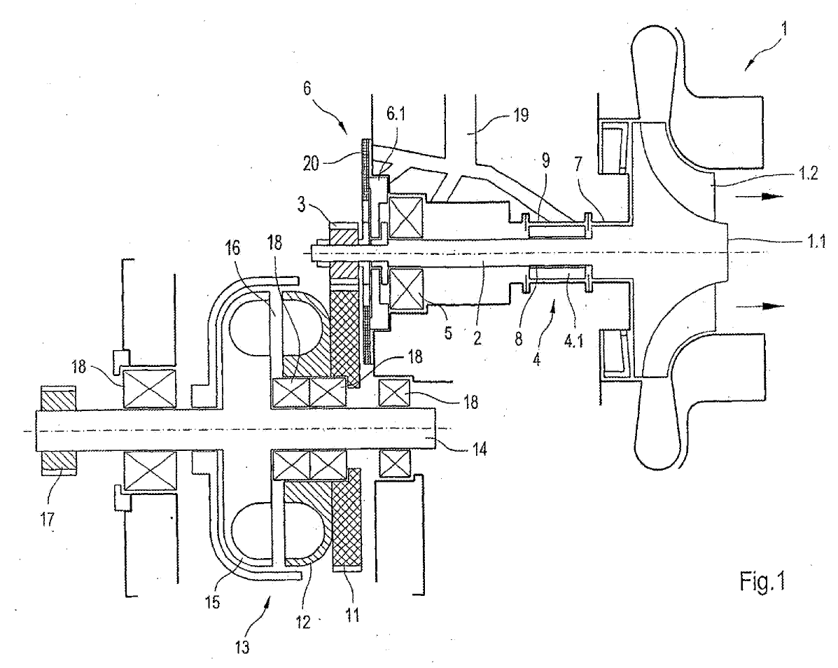

An exhaust-gas power-recovery turbine 1 and its rotor 1.1 can be seen in FIG. 1 with a plurality of turbine blades 1.2, which are arranged in the exhaust gas stream (see direction arrows) of an internal combustion engine (non-represented). As can be seen, the exhaust-gas power-recovery turbine 1 is designed as a radial-axial-turbine, which means that the turbine blades 1.2 are exposed to the flow of exhaust gas radially from the outside which then leaves it in axial direction (flows out).

The rotor 1.1 is carried by a turbine shaft 2—to be more accurate, is formed as a single-part therewith. In that case, the rotor 1.1 of the exhaust-gas power-recovery turbine is flush therewith on an axial end of the turbine shaft 2.

A pinion 3 is arranged on the turbine shaft 2, i.e. on the opposite second axial end of the turbine shaft 2; to be more accurate said pinion 3 is carried by said shaft 2. In this instance, the pinion 3 is suspended on the turbine shaft 2 and is held there by an appropriate mechanical locking system, to be more accurate by spacers. Alternately, the pinion 3 could also be formed as a single piece with the turbine shaft 2.

The pinion 3 meshes with a gear 11, which is connected in a torque-proof manner to the pump wheel 12 of a hydrodynamic coupling 13. The gear 11 is here relatively supported on a coupling shaft 14 together with the pump wheel 12, which means that it rotates with another rotation speed than the shaft. The coupling shaft 14 carries the turbine wheel 15 of the hydrodynamic coupling in a torque-proof manner, which turbine wheel 15 forms together with the pump wheel 12 a hydrodynamic work space 16. The drive power can thus be transmitted hydrodynamically to the turbine wheel 15 via the pinion 3, the gear 11, the pump wheel 12, and from there to the crankshaft (or generally the output shaft) of the internal combustion engine via the coupling shaft 14, which is arranged in a torque-proof manner, by means of the coupling shaft pinion 17.

The represented mounting of the pump wheel 12 of the hydrodynamic coupling or of the coupling shaft 14 can be designed independent of the configuration of the arrangement or of the mounting of the turbine shaft 2 in the illustrated form, in particular with four roller bearings 18 connected behind one another in axial direction, among which both middle bearings can be combined to constitute a double bearing. It is particularly referred to the fact that said bearing arrangement or generally the mounting of the coupling shaft 14 and of the corresponding components in the region of the hydrodynamic coupling 13 in particular in turbo compound systems can be formed without the mounting of the turbine shaft of the exhaust-gas power-recovery turbine, illustrated according to the invention, with a radial plain bearing and a radial roller bearing.

According to FIG. 1, the turbine shaft 2 is supported in the area of the rotor 1.1 by means of a radial plain bearing 4 and in the area of the pinion 3 by means of a radial rolling-element bearing 5. Both bearings 4, 5 are hence arranged between the pinion 3 and the rotor 1.1 as seen in axial direction and the single radial bearings, by means of which the turbine shaft 2 is supported, so that the rotor 1.1 as well as the pinion 3 are arranged or supported cantilevered on the turbine shaft 2.

The radial rolling-element bearing 5 as well as the radial plain bearing 4 are enclosed by a common housing 7 in around the periphery. The bearings can hence, as already mentioned, be supplied with pressurised oil via a pressurised oil system 19 or lubricating oil (without overpressure).

The radial plain bearing 4 particularly advantageously includes a so-called floating bushing, which means that as seen in radial direction, two lubricating oil-filled annular gaps are arranged behind one another. One or both annular gaps can be filled with pressurised oil, to exert a damping effect on the dynamic forces, to which the turbine shaft 2 is subject. The radial plain bearing 4 has for instance a bearing ring 4.1, in particular a cylinder ring, which is arranged in radial direction of the turbine shaft 2 between the turbine shaft 2 and a housing 7, and forms both aforementioned annular gaps 8, 9 with the housing 7 or with the turbine shaft 2.

In the illustrated embodiment, the radial rolling-element bearing 5 has conversely no such floating bushing or squeeze oil damper. Far more, the bearing outer ring (non-represented) of the radial rolling-element bearing 5 is inserted directly and in a torque-proof manner in the housing 7 and the bearing inner ring (non-represented) is mounted on the turbine shaft 2 directly and in a torque-proof manner. A plurality of rolling elements is arranged between the bearing outer ring and the bearing inner ring, so that the bearing outer ring and the bearing inner ring roll off each other over the rolling elements (non-represented).

In the exemplary embodiment illustrated in FIG. 1, the turbine shaft 2 is held by an axial plain bearing 6. This is positioned in the area of the pinion 3 and can, as represented, be mounted outside on the housing 7 and in particular be covered by a bearing shield 20 from the outside. In this instance, the axial plain bearing 6 comprises a fixed bearing ring 6.1 mounted in or on the housing 7, which is supported via respectively a lubricating oil film on two spacers mounted fixedly in axial direction on the turbine shaft 2.

It is of course also possible to provide one or also three or more spacers instead of the two illustrated spacers.

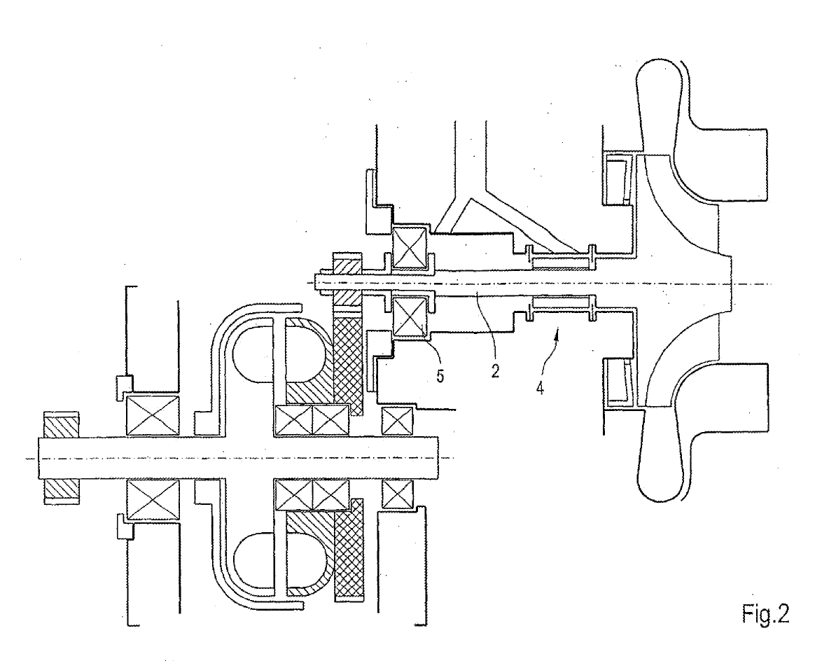

The embodiment according to FIG. 2 differentiates from that of FIG. 1 in that the turbine shaft 2 has no axial plain bearing and the radial plain bearing 5 fulfills the function of an axial bearing at the same time. For that purpose, the radial roller bearing 5 (then axial-radial-roller bearing) is supported either via rolling elements on the housing and/or an axial base of the turbine shaft 2 or via a lubricating oil, for instance again between a bearing ring of the bearing 5 and spacers on the turbine shaft 2. Other embodiments can be envisioned.

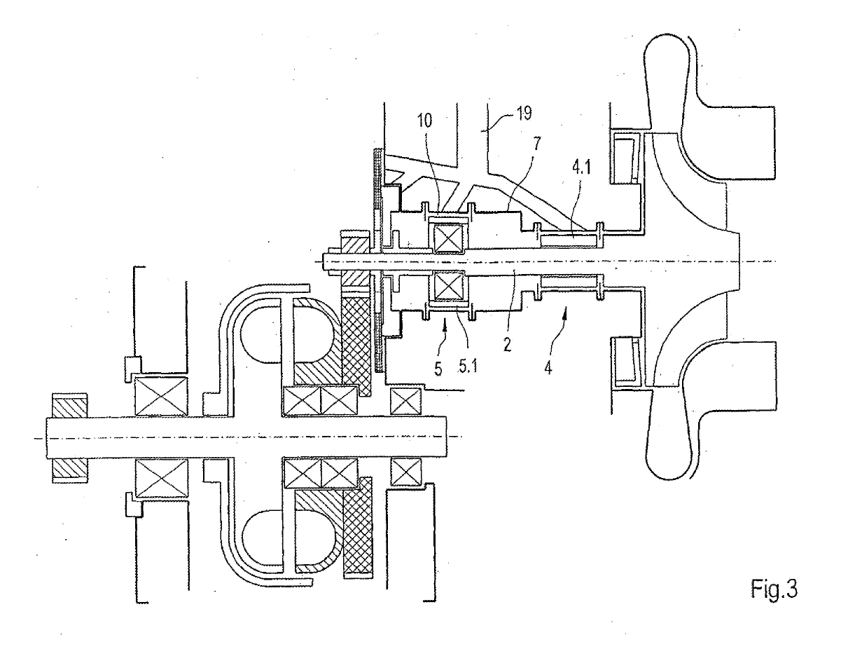

The embodiment according to FIG. 3 differentiates from that of FIG. 1 in that the radial roller bearing 5 is also fitted with a so-called floating bushing. In the illustrated embodiment variation, a bearing ring 5.1 is provided to that end, which the outer ring of the radial rolling-element bearing 5 is pressed into. An annular gap is formed between the bearing ring 5.1 and the housing 7, which is filled with lubricating oil, in particular pressurised oil. The dynamic forces acting on the turbine shaft 2 or the bearing 5 are hence attenuated, and the wear of the bearing can be reduced.

The bearing ring 5.1 can for instance be fixed, as already mentioned, by circlips in axial direction, similar to the bearing ring 4.1 of the radial plain bearing 4 illustrated in the figures. The pressurised oil in the annular gap 10 between the bearing ring 5.1 and the housing 7 can be made available for instance again using the pressurised oil system 19, which is in a correspondingly conductive connection with the annular gap 10.

Alternately or additionally, a corresponding lubricating oil or pressurised oil-filled annular gap may also be provided between the bearing inner ring and the turbine shaft 2.

The features illustrated in FIGS. 1, 2 and 3 can be provided independently from one another or in non-represented combinations. It is of course also possible to realise the radial plain bearing 4 without the floating bushing, that is to say with a single lubricating oil-filled annular gap between the housing 7 and the turbine shaft 2. Other modifications can be envisioned.

The turbine shaft 2 of a turbo compound system according to the invention rotates for instance with rotation speeds of up to 70,000 rpm, in particular with maximum rotation speeds above 20,000, 30,000 or 40,000 rpm.

The lubricating oil or pressurised oil-filled bearing spaces or annular gaps 8, 9, 10 of the bearings 4, 5, in particular the annular gap 10 in the radial roller bearing 5, can be sealed with respect to the housing 7 and the respective bearing ring 5.1, 4.1, for instance can be designed with a contactless or a contacting shaft seal, such as a tip-to-tip seal, a labyrinth seal or an O-ring.

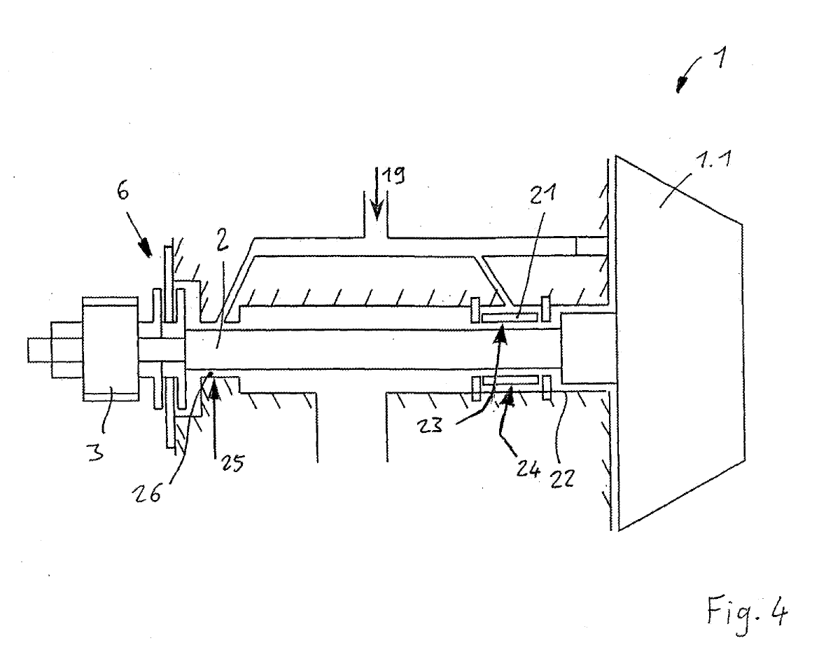

In the embodiment according to FIG. 4, in which matching components are again designated with matching reference signs, the turbine shaft 2 is supported in the area of the rotor 1.1 by means of a floating bushing 21 in a housing 22. The component designated here as a floating bushing 21 corresponds in its function to the bearing ring 4.1 according to FIG. 1, whereas accordingly the radial plain bearing 4 according to FIG. 1 could also be designated as a floating bushing bearing.

As can be seen in FIG. 4, the floating bushing 21 forms an external oil-filled bearing gap 23 with respect to the housing 22 and an internal oil-filled bearing gap 24 with respect to the turbine shaft 2. Besides, the floating bushing 21 is relatively rotatable with respect to the housing 22 and with respect to the turbine shaft 2.

In the area of the pinion 3 conversely, the turbine shaft 2 is only supported by means of a simple plain bearing 25 in the housing 22 (or another component), and a single oil-filled bearing gap 26 has no rolling elements between the turbine shaft 2 and the housing 22 or the other component. It is hence sufficient according to the invention to provide a single simple plain bearing in the area of the pinion 3 for supporting the turbine shaft, whereas the bearing can be positioned either on the side pointing to the rotor 1.1 or also on the side of the pinion 3 facing away from the rotor 1.1. In an embodiment of the rotor 1.1 being a compressor rotor, which is arranged in a fresh air flow of an internal combustion engine, as will be described more in detail below, several plain bearings can also be provided close to the pinion 3 according to a deviating form of embodiment, in particular exactly two plain bearings, advantageously one on each side of the pinion 3, which then either all or both are designed as a simple plain bearing, or among which only one or several, however not all of them, can be designed as straightforward plain bearings and the remaining one(s) as floating bushing bearings.

An axial plain bearing 6 is also provided in the form of embodiment illustrated in FIG. 4 or also in this special case on the side of the simple plain bearing 25 facing away from the rotor 1.1 and close to the pinion 3.

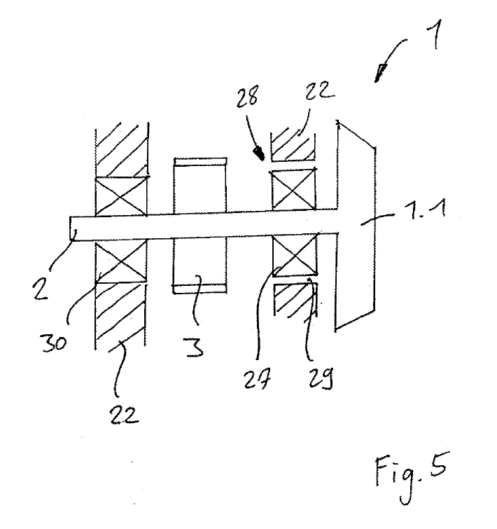

FIG. 5 illustrates the third arrangement according to the present invention. The pinion 3 is this time not supported cantilevered, but rather between the bearing close to the pinion 3 and the bearing close to the rotor 1.1. It would of course be also possible to support the pinion 3 in a cantilevered manner, or vice versa, in the embodiments illustrated previously, the pinion 3, as represented in FIG. 5, could also be supported in a non-cantilevered manner.

According to FIG. 5, the turbine shaft 2 is supported in the area of the rotor 1.1 by means of a roller bearing 27, which is enclosed by a plain bearing 28 with an oil-filled bearing gap 29. The external bearing ring of the roller bearing 27 rotates by the plain bearing 28 with respect to the facing surface of the housing 22. If conversely the external bearing ring of the roller bearing 27 is held stationary according to an embodiment of the invention and nevertheless is enclosed by an oil-filled bearing gap 29, into which in particular pressurised oil is injected, the term oil damper or squeeze oil damper would be more suitable than the designation plain bearing. Such an oil damper has already been described with reference to FIG. 3 as regards the bearing close to the pinion 3.

The bearing close to the pinion 3 in the region of the other end of the turbine shaft 2 according to FIG. 5 conversely is designed as a simple roller bearing without floating bushing, which means that no oil-filled bearing gap without rolling elements is provided in said bearing. This straightforward roller bearing is indicated by the reference sign 30.

Both bearings 27, 30 according to the embodiment variation in FIG. 5 thus differentiate from each other in that the bearing close to the rotor is supported as a roller bearing 27 over a plain bearing 28 with a bearing gap 29 in the housing 22 (or another appropriate component) whereas conversely the roller bearing 30 close to the pinion 3 is directly supported in the housing 22 (or another appropriate component), that is to say without interposition of a plain bearing.

In deviation from the illustration of FIG. 5, two oil-filled bearing gaps can also be provided outside the roller bearing 27 inasmuch as the roller bearing 27 for instance is supported in a floating bushing, which forms a first oil-filled bearing gap with respect to the roller bearing 27 and a second oil-filled bearing gap with respect to the housing 22 or another appropriate component. Alternately or additionally, such a floating bushing bearing assembly having two oil-filled bearing gaps or only one oil-filled bearing gap could also be provided between the roller bearing 27 and the turbine shaft 2.

In a turbo charger system (non-represented), whose exhaust gas turbine which is in drive connection with a fresh air compressor of the internal combustion engine in particular directly via a rigid shaft, and which in particular is arranged in the flow direction of exhaust gas upstream of the exhaust-gas power-recovery turbine, the mounting concept illustrated in this instance for the exhaust-gas power-recovery turbine can also be designed accordingly and more precisely regardless whether a turbo compound system is provided.

Although the present invention has been illustrated previously using an exhaust-gas power-recovery turbine for a turbo compound system, it can similarly be used with a turbo compressor for a turbo compound system or for a turbo charger, in particular of a motor vehicle. In such a case, the turbine shaft is suitably designated as a drive shaft and the rotor is a compressor rotor, not a turbine rotor. Moreover, the rotor is driven by the drive power applied by the pinion to the drive shaft and compresses a fresh air flow fed to the internal combustion engine, instead of converting exhaust gas energy into drive power. The drive power can be made available by a turbine, in particular exhaust gas turbine or by the crankshaft of the internal combustion engine. A gas turbine or a vapour can be envisioned as well instead of an exhaust gas turbine, for instance a steam turbine in a steam cycle, wherein steam in particular is generated by means of exhaust gas energy. Incidentally, the features described previously are accordingly relevant for the configuration of a turbo compressor according to the invention. This applies in particular to the arrangement and embodiment of the bearing, in particular of the axial bearing respectively its integration into the radial rolling-element bearing, as well as the embodiment as a floating bushing. But the other features described with reference to the exhaust-gas power-recovery turbine can also be used with the embodiment as a turbo compressor.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An exhaust-gas power-recovery turbine for a turbo compound system of a motor vehicle, said exhaust-gas power-recovery turbine comprising:
a rotor;
a pinion;
a radial plain bearing;
a radial rolling-element bearing;
a turbine shaft including a first end, a second end, an area of said first end, an area of said rotor, and an area of said pinion, said turbine shaft, one of at said first end of said turbine shaft and in said area of said first end of said turbine shaft, carrying said rotor which is configured for being impinged by an exhaust gas flow of an internal combustion engine in order to convert an exhaust gas energy into a drive power, said turbine shaft, at said second end of said turbine shaft, carrying said pinion, said pinion being configured for being brought into a driving connection with a crankshaft of said internal combustion engine in order to transmit said drive power to said crankshaft, said turbine shaft being supported in said area of said rotor by way of said radial plain bearing and in said area of said pinion by way of said radial rolling-element bearing.

2. The exhaust-gas power-recovery turbine for a turbo compound system according to claim 1, further including an axial plain bearing, said turbine shaft being further supported in said area of said pinion with said axial plain bearing, said axial plain bearing being the single axial bearing by way of which said turbine shaft is supported.

3. The exhaust-gas power-recovery turbine for a turbo compound system according to claim 2, wherein said radial rolling-element bearing is arranged in an axial direction of said turbine shaft between said axial plain bearing and said radial plain bearing.

4. The exhaust-gas power-recovery turbine for a turbo compound system according to claim 1, wherein said radial rolling-element bearing is additionally formed as an axial bearing which is the single axial bearing by way of which said turbine shaft is supported.

5. The exhaust-gas power-recovery turbine for a turbo compound system according to claim 1, further including a stationary housing, wherein said radial plain bearing has a bearing ring, said bearing ring being arranged in a radial direction of said turbine shaft between said turbine shaft and said stationary housing, said stationary housing being non-rotating, said bearing ring and said stationary housing forming therebetween a first lubricating oil-filled annular gap, said bearing ring and said turbine shaft forming therebetween a second lubricating oil-filled annular gap.

6. The exhaust-gas power-recovery turbine for a turbo compound system according to claim 5, wherein said bearing ring is a cylinder ring.

7. The exhaust-gas power-recovery turbine for a turbo compound system according to claim 1, further including a stationary housing, wherein said radial rolling-element bearing has a bearing ring which is arranged in a radial direction of said turbine shaft between said turbine shaft and said stationary housing, at least one of (a) said bearing ring and said stationary housing and (b) said bearing ring and said turbine shaft forming therebetween a lubricating oil-filled annular gap, in which a static overpressure is adjusted.

8. The exhaust-gas power-recovery turbine for a turbo compound system according to claim 7, wherein said radial rolling-element bearing has an inner ring, an outer ring surrounding said inner ring, and a plurality of rolling elements inserted between said inner ring and said outer ring so that said inner ring and said outer ring roll off each other over said plurality of rolling elements, said plurality of rolling elements being formed as a plurality of one of cylinders, cones, and needles, said bearing ring one of (a) being formed integrally with one of said inner ring and said outer ring and (b) being mounted on one of said inner ring and said outer ring by force fitting.

9. The exhaust-gas power-recovery turbine for a turbo compound system according to claim 1, wherein said radial rolling-element bearing has a plurality of rolling elements, said plurality of rolling elements being made of a ceramic material and being formed as a plurality of one of cylinders, cones, and needles,

10. The exhaust-gas power-recovery turbine for a turbo compound system according to claim 1, further including an axial plain bearing and a common housing, wherein said radial plain bearing, said radial rolling-element bearing, and said axial plain bearing, by way of which said turbine shaft is supported, at least one of are enclosed by said common housing and are mounted on said common housing.

11. The exhaust-gas power-recovery turbine for a turbo compound system according to claim 1, wherein said first end and said second end of said turbine shaft are external axial ends of said turbine shaft, wherein at least one of said pinion and said rotor are supported cantilevered on said turbine shaft respectively opposite one another on said external axial ends of said turbine shaft.

12. An exhaust-gas power-recovery turbine for a turbo compound system of a motor vehicle, said exhaust-gas power-recovery turbine comprising:
a rotor;
a pinion;
a floating bushing;
at least one of a first housing and a second housing;
a simple plain bearing;
a turbine shaft including a first end, a second end, an area of said first end, an area of said rotor, and an area of said pinion, said turbine shaft, one of at said first end of said turbine shaft and in said area of said first end of said turbine shaft, carrying said rotor which is configured for being impinged by an exhaust gas flow of an internal combustion engine in order to convert an exhaust gas energy into a drive power, said turbine shaft, at said second end of said turbine shaft, carrying said pinion, said pinion being configured for being brought into a driving connection with a crankshaft of said internal combustion engine in order to transmit said drive power to said crankshaft, said turbine shaft being supported in said area of said rotor by way of said floating bushing in said first housing, said floating bushing forming an external oil-filled bearing gap with respect to said first housing and an internal oil-filled bearing gap with respect to said turbine shaft, said floating bushing being relatively rotatable with respect to said first housing and said turbine shaft, said turbine shaft being supported in said area of said pinion by way of a single said simple plain bearing which forms in a radial direction a single oil-filled bearing gap between said turbine shaft and one of said first housing and said second housing.

13. An exhaust-gas power-recovery turbine for a turbo compound system of a motor vehicle, said exhaust-gas power-recovery turbine comprising:
a rotor;
a pinion;
a roller bearing;
one of a plain bearing and an oil damper with an oil-filled bearing gap;
a simple roller bearing;
a turbine shaft including a first end, a second end, an area of said first end, an area of said rotor, and an area of said pinion, said turbine shaft, one of at said first end of said turbine shaft and in said area of said first end of said turbine shaft, carrying said rotor which is configured for being impinged by an exhaust gas flow of an internal combustion engine in order to convert an exhaust gas energy into a drive power, said turbine shaft, at said second end of said turbine shaft, carrying said pinion, said pinion being configured for being brought into a driving connection with a crankshaft of said internal combustion engine in order to transmit said drive power to said crankshaft, said turbine shaft being supported in said area of said rotor by way of said roller bearing at least one of which is enclosed by one of said plain bearing and said oil damper with said oil-filled bearing gap and which encloses said plain bearing, said turbine shaft being supported in said area of said pinion by way of a simple roller bearing which has no enclosing or enclosed oil-filled bearing gap of a plain bearing or an oil damper.

14. The exhaust-gas power-recovery turbine according to claim 13, further including a floating bushing and a housing, said roller bearing being supported in said floating bushing, said floating bushing forming an internal oil-filled bearing gap with respect to said roller bearing and an external oil-filled bearing gap with respect to said housing and being rotatable relatively with respect to said roller bearing and with respect to said housing.

15. The exhaust-gas power-recovery turbine according to claim 14, wherein said roller bearing includes an external bearing ring, said floating bushing being rotatable relative with respect to said external bearing ring and with respect to said housing.

16. A flow compressor for one of a turbo compound system and a turbo charger of a motor vehicle, said flow compressor comprising:
a rotor;
a pinion;
a radial plain bearing;
a radial rolling-element bearing;
a drive shaft including a first end, a second end, an area of said first end, an area of said rotor, and an area of said pinion, said drive shaft, one of at said first end of said drive shaft and in said area of said first end of said drive shaft, carrying said rotor which is configured for being positioned in a fresh air flow leading to an internal combustion engine in order to compress said fresh air flow, said drive shaft, at said second end of said drive shaft, carrying said pinion, said pinion being configured for being brought into a driving connection with a crankshaft of one of said internal combustion engine, a turbine, and an exhaust gas turbine in order to transmit a drive power to said rotor, said drive shaft being supported in said area of said rotor by way of said radial plain bearing and in said area of said pinion by way of said radial rolling-element bearing.

17. A flow compressor for one of a turbo compound system and a turbo charger of a motor vehicle, said flow compressor comprising:
a rotor;
a pinion;
a floating bushing;
at least one of a first housing and a second housing;
a simple plain bearing;
a drive shaft including a first end, a second end, an area of said first end, an area of said rotor, and an area of said pinion, said drive shaft, one of at said first end of said drive shaft and in said area of said first end of said drive shaft, carrying said rotor which is configured for being positioned in a fresh air flow leading to an internal combustion engine in order to compress said fresh air flow, said drive shaft, at said second end of said drive shaft, carrying said pinion, said pinion being configured for being brought into a driving connection with a crankshaft of one of said internal combustion engine, a turbine, and an exhaust gas turbine in order to transmit a drive power to said rotor, said drive shaft being supported in said area of said rotor by way of said floating bushing in said first housing, said floating bushing forming an external oil-filled bearing gap with respect to said first housing and an internal oil-filled bearing gap with respect to said drive shaft, said floating bushing being relatively rotatable with respect to said first housing and said drive shaft, said drive shaft being supported in said area of said pinion by way of one of at least one and a single said simple plain bearing which forms in a radial direction a single oil-filled bearing gap between said drive shaft and one of said first housing and said second housing.

18. A flow compressor for one of a turbo compound system and a turbo charger of a motor vehicle, said flow compressor comprising:
a rotor;
a pinion;
a roller bearing;
one of a plain bearing and an oil damper with an oil-filled bearing gap;
a simple roller bearing;
a drive shaft including a first end, a second end, an area of said first end, an area of said rotor, and an area of said pinion, said drive shaft, one of at said first end of said drive shaft and in said area of said first end of said drive shaft, carrying said rotor which is configured for being positioned in a fresh air flow leading to an internal combustion engine in order to compress said fresh air flow, said drive shaft, at said second end of said drive shaft, carrying said pinion, said pinion being configured for being brought into a driving connection with a crankshaft of one of said internal combustion engine, a turbine, and an exhaust gas turbine in order to transmit a drive power to said rotor, said drive shaft being supported in said area of said rotor by way of said roller bearing at least one of which is enclosed by one of said plain bearing and said oil damper with said oil-filled bearing gap and which encloses said plain bearing, said drive shaft being supported in said area of said pinion by way of a simple roller bearing which has no enclosing or enclosed oil-filled bearing gap of a plain bearing or an oil damper.
